(19) United States
(12) Patent Application Publication
(10) Pub. No.: US 2005/0086073 A1
(43) Pub. Date: Apr. 21, 2005

(54) System and method for storing and retrieving medical directives

(76) Inventors: Theodore Rodes JR., Winnetka, IL (US); Paul F. Dittmann, Chicago, IL (US)

Correspondence Address: Jeffrey R. Gargano, Esq.;Wallenstein Wagner & Rockey, Ltd., 311 South Wacker Drive, 53rd Floor, Chicago, IL, 60606-6630, US

(21) Appl. No.: 10/686,144

(22) Filed: Oct. 15, 2003

(51) Int. Cl. G06F 17/60; G06F 7/00; G06F 17/00

(52) U.S. Cl. 705/2; 707/104.1

(57) ABSTRACT

A system and method for storing and retrieving medical directives is provided. Medical directives are received from a plurality of members and stored retrievably in memory. A request is received for a medical directive from a requesting user, the request comprising either the name, identification number, or name and identification number, of the member. The memory is searched for a medical directive corresponding to the information provided by the requesting user, and a corresponding medical directive is made available to the requesting user.

### FIELD OF THE INVENTION

The present invention relates to instructions for medical care. More particularly, the present invention relates to a system and method for electronically storing and retrieving medical directives.

### BACKGROUND OF THE INVENTION

The Internet comprises a vast number of computers and computer networks that are interconnected through communication links. The interconnected computers exchange information using various services, such as electronic mail and the World Wide Web (“web”). The web service allows a server computer system (i.e., a web server or web site) to send graphical web pages of information to a remote client computer system. The remote client computer system can then display the web pages on a display screen, for example, a cathode ray tube or digital display. Each resource (e.g., web server or web page) of the web is uniquely identifiable by a Uniform Resource Locator (“URL”). To view a specific web page, a client computer system specifies the URL for that web page in a request for information. Typically, a request for web information is made using the Hyper-Text Transfer Protocol. The request is forwarded to the web server corresponding to the provided URL. When that web server receives the request, it sends the web page corresponding to the provided URL to the client computer system. When the client computer system receives that web page, it typically displays the web page using a browser. A browser is a special-purpose application program that effects the requesting of web pages and the displaying of web pages on a display screen.

Currently, web pages are typically defined using the Hyper-Text Markup Language (“HTML”). HTML provides a set of instructions that define how a web page is to be displayed. When a user indicates to the browser to display a web page, the browser sends a request to the server computer system to transfer to the client computer system an HTML document that defines the web page. When the requested HTML document is received by the client computer system, the browser displays the web page as described by the HTML document. The HTML document contains various instructions that control the displaying of text, graphics, controls, and other features. The HTML document may contain URLs of other web pages available on that server computer system or other server computer systems.

An important feature of the web is the ability to connect one web page to many other web pages using “hypertext” links. A link typically appears unobtrusively as an underlined portion of text in a web page; when the user of this page moves a pointer over the underlined text and clicks, the link—which is otherwise invisible to the user—is executed and the linked web page is retrieved. Generally, it is not necessary for the retrieved web page to be located on the same server as the original web page.

Typically, the design of a web page is based on the HTML code of that web page. The design and content of some web pages, however, are based on other programming languages. For example, web page content may be based on Java, JavaScript, Perl, ColdFusion, or Active Server Pages. These programming languages typically complement HTML-encoded web pages and provide additional functionality to the web page.

The content of web pages may also be based on the content of one or more databases. Any relational or non-relational database or spreadsheet may be used to store information which may be retrieved and displayed on a web page. Exemplary of database platforms which may be used in this capacity are Microsoft Access, Oracle, Sequential Query Language (“SQL”), and Microsoft Excel. A web page may include a “database connection layer” which dynamically generates the content of a web page by accessing the data stored in these one or more databases. The database connection layer is typically written in a programming language such as JavaScript, MySQL, Lotus Notes, ColdFusion, Active Server Pages, or Informix. These languages greatly improve the efficiency of the web, because they allow HTML-encoded web pages to be dynamically generated based on information stored in a database. The database connection layer allows the designers of web pages to create a single template web page which may then be populated with information via the database connection layer, such that a single template web page may in effect spawn thousands of different and unique web pages.

A web page may also be connected to a “workflow management system,” which enables web page servers to perform tasks without human oversight. For example, a workflow management system may provide for purchase orders to be received through a web page. The workflow management system may check to ensure that the necessary information has been received via the web page, properly format the received information, send the information to another web server, and send a confirmation to the user of the web page, all of these steps being performed without human oversight of the web page server. Exemplary of commercially-available workflow management systems are Websphere, Lotus Notes, and Microsoft Exchange.

Additionally, web pages may be enabled so as to limit access only to certain users. For example, a user may be required to enter a password to a web page before gaining access to the web pages which comprise the rest of the web site. As another example, the user may be required to enter a personal identification number (“PIN”) before gaining access to the web site. Using a properly equipped computer, a user may also be required to provide additional identifying information, such as a retinal scan or fingerprint scan, before gaining access to a web site.

One of the benefits of the web is the accessibility of information. Thus, the web has become increasingly used to share electronic information between users of the Internet. In particular, the web has been increasingly used to store and retrieve medical information and medical directives such as living wills and medical care instructions.

Web sites offering storage and retrieval of medical directives generally allow users of the system to electronically store medical directives at the web site by scanning or “uploading” the documents to the site. These sites generally restrict access to the medical directives to the users themselves. To obtain access to the medical directives, the user must enter a user name and password. Some of these sites provide access to the medical directives upon the provision of an identification number and password. These sites generally do not provide access to stored medical directives to users who have not provided the password of a registered user of the system.

### SUMMARY OF THE INVENTION

The present invention provides a system in which users may store and retrieve medical directives. The invention provides for multiple modes for submitting medical directive information to the system, and provides for multiple modes of access to the stored medical directives. In particular, the invention provides for access to the medical directives without requiring that the user retrieving the medical directive from the system be the user which stored the medical directive on the system. As a result, medical professionals may readily gain access to medical directives of their patients, and healthcare agents may readily obtain the information necessary to fulfill their obligations in accordance with patients' medical directives.

A system and method for storing and retrieving a plurality of medical directives corresponding to a plurality of members is disclosed in which members provide medical directives, for example, living wills and patient care instructions, to the system. In one embodiment of the present invention, the medical directives are stored in a memory and are thereafter retrievable from the memory. The system receives a user request for a medical directive associated with one of the members of the system, and the system displays the medical directive to the requesting user.

In another embodiment of the present invention, a system and method for storing and retrieving medical directives is provided in which members may store medical directives on the system by electronically “uploading” the medical directives to the system, by electronically mailing the documents to the system, by mailing the medical directives to the system, and by other methods of submitting the medical directives to the system.

In yet another embodiment of the present invention, a system and method for storing and retrieving medical directives is disclosed in which a request for a stored medical directive comprises a member name, a member identification number, or a member name in combination with an identification number. The medical directives are provided to the requesting user upon receipt of this information, and are provided independent of whether the requesting user is the member who stored the medical directives to the system.

In yet another embodiment of the present invention, a system and method for storing and retrieving medical directives is provided in which users may request information from the system that indicates whether a member of the system has a corresponding medical directive stored on the system. The system receives a request from a user comprising a full or partial member name, a member identification number, or a member name in combination with an identification number. In response, the requesting user receives a notification indicating whether the identified member has a corresponding medical directive stored on the system.

Other features and advantages of the invention will be apparent from the following specification taken in conjunction with the following drawings.

### BRIEF DESCRIPTION OF THE DRAWINGS

FIG. 1 is the primary flowchart of the system and method for storing and retrieving medical directives related to receiving a medical directive from a member, storing the medical directive on the system and then transmitting the medical directive to a requesting user.

FIG. 2 is a flowchart of the system and method for storing and retrieving medical directives related to the methods by which a member may submit medical directives to the system.

FIG. 3 is a flowchart of the system and method for storing and retrieving medical directives related to the methods by which a requesting user may request a medical directive stored on the system, and further related to transmitting a notification to a requesting user indicating whether a member has a medical directive stored on the system.

FIG. 4 is an illustration of the components of a system for storing and retrieving medical directives, detailing the interaction and communication between the components of the system in accordance with one embodiment of the present invention.

FIG. 5 is an illustration of a web page designed in accordance with the principles of the present invention. The web page contains a form for the entry of identifying information, thereby enabling a user of the system to retrieve a medical directive corresponding to one of the members.

FIG. 6 is an illustration of a web page designed in accordance with the principles of the present invention. The figure illustrates one version of a web page which may be presented to a requesting user of the system, in response to a requesting user's request for a member's medical directive.

### DETAILED DESCRIPTION OF THE INVENTION

While this invention is susceptible of embodiment in many different forms, there are shown in the drawings and herein described in detail preferred embodiments with the understanding that the present disclosure is to be considered an exemplification of the principles of the invention and is not intended to limit the broad aspects of the invention to the embodiments illustrated.

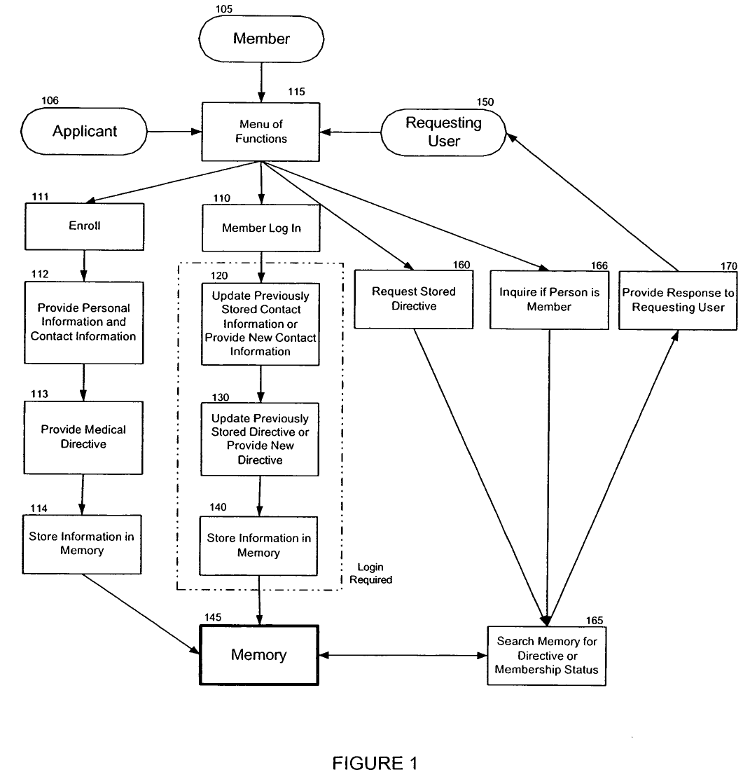

Referring in detail to the drawings and initially to FIG. 1, there is provided a system and method for storing and distributing medical directives. A medical directive is an instruction given from one person to another person. Typically, a medical directive is provided from a patient to a medical provider such as a doctor or nurse. A medical directive may be a document, such as a living will, a power of attorney, an assignment, or a medical instruction. A medical directive may be an audio recording or a video recording, or may be any combination of written, audio, or video information. All such types of medical directives are practicable in accordance with the principles of the present invention.

Users of the system are of three types: applicants, members, and requesting users. Applicants can store their personal and contact information on the systems at step 112. Step 112 may comprise: electronically entering the data in the enrollment form on the web site, electronically mailing a completed enrollment form to a predetermined electronic mail address, faxing a completed enrollment form to a predetermined telephone number, or physically mailing a completed enrollment form to a predetermined postal address. The personal and contact information is stored in a memory 145, the memory 145 capable of being searched, in step 114.

The applicant may also electronically store one or more medical directives on the system in step 113. Step 113 may comprise: electronically uploading a file comprising a medical directive to the system, electronically mailing a file comprising a medical directive to a predetermined electronic mail address, or physically mailing a medical directive to a predetermined postal address. The medical directive is stored in a memory 145, the memory 145 capable of being searched, in step 114.

The applicant 106 may also be presented with an option to pay membership fees. Paying membership fees may comprise providing credit card information over a secure Internet connection or mailing a personal check or money order to a postal address, or by other equivalent means of performing payment of the membership fees.

A second type of user of the system is a member 105. Members 105 have established user accounts with the system, and log into the system in step 110. The member 105 may be required to provide a member name, a member identification number, a password, a member name in combination with member identification number and/or a password, or other identification information in order to log into the system in step 110.

A member 105 may update its personal and contact information on the sysstem at step 120. Step 120 may comprise: electronically entering data in the “maintain enrollment” data form on the web site, electronically mailing a “revised enrollment” form to a predetermined electronic mail address, faxing a “revised enrollment” form to a predetermined telephone number, or physically mailing a “revised enrollment” form to a predetermined postal address. The personal and contact information is stored in a memory 145, the memory 145 capable of being searched, in step 140.

The member 105 may electronically store one or more medical directives on the system in step 130. Step 130 may comprise: electronically uploading a file comprising a medical directive to the system, electronically mailing a file comprising a medical directive to a predetermined electronic mail address, or physically mailing the medical directive to a predetermined postal address. The medical directive is stored in a memory 145, the memory 134 capable of being searched, in step 140.

The third type of user of the system is a requesting user 150. A requesting user 150 requests a medical directive corresponding to a member 105 in step 160. The request from the requesting user 150 may comprise a member name, a member identification number, a member name and identification number in combination, or some other identification information. The identification number received from the requesting user 150 may be a predetermined unique identification number assigned to a member 105 by the system, or may be another identification number corresponding to a member 105, for example, the member's 105 social security number.

Using the identification information provided by the requesting user 150, the memory 145 is searched for a medical directive corresponding to the identification information provided. If a medical directive matching the provided identification information is found in the memory 145, corresponding emergency contact information and the corresponding directive may be made available to the requesting user in step 170. Providing for the availability of the corresponding medical directive to the requesting user 150 may comprise: displaying the corresponding medical directive on a computer display, electronically mailing the corresponding medical directive to the requesting user 150, physically mailing the corresponding medical directive to the requesting user's 150 postal address, or providing the requesting user 150 with a password enabling the electronic display of the corresponding medical directive.

Using the identification information provided by the requesting user 150, the requesting user 150 may also determine whether an individual is a member 105 of the system, in step 166. The requesting user 150 may provide identification information about an individual to the system, and may request of the system information indicating whether the individual is a member 105. If the requesting user 150 selects this function, the memory 145 is searched for a member profile corresponding to the information provided by the requesting user 150. Then, in step 170, the requesting user 150 may be notified whether an individual is a member 105 of the system.

Users of the system may change between the different types of users, and also may simultaneously be of different types. For example, a requesting user 150 may also be a member 105, and a member 105 may also be a requesting user 150. A member 105 may, by providing new enrollment information, be an applicant 106, and an applicant 106 may also be a requesting user 150. The different types of users are merely illustrative of the various functions available to users of the system, and are not intended to indicate that an individual user may not simultaneously be of two or more types.

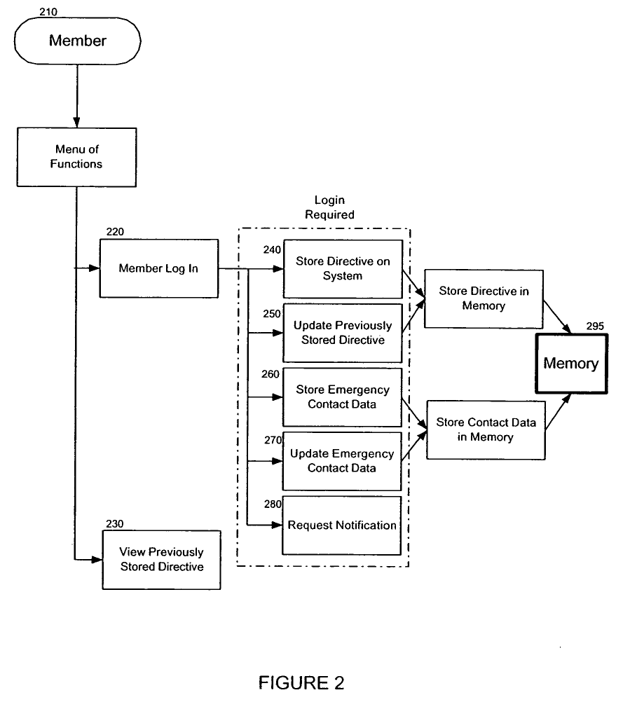

FIG. 2 further details a method for storing medical directives in accordance with one embodiment of the present invention. A member 210 logs into the system in step 220. The member 210 may be required to provide a member name, a member identification number, a password, a member name in combination with member identification number and/or a password, or other identification information in order to log into the system in step 220.

The member 210 may electronically store a medical directive on the system in step 240. Storing a medical directive on the system in step 240 may comprise: electronically uploading a file comprising a medical directive to the system, electronically mailing a file comprising a medical directive to a predetermined electronic mail address, or physically mailing the medical directive to a predetermined postal address.

The member 210 may electronically update previously stored medical directives on the system in step 250. Electronically updating a previously stored medical directive may be accomplished by methods similar to those methods use to initially store a medical directive on the system in step 240.

The member 210 may, in step 260, electronically store on the system emergency contact information corresponding to the member 210. Such information may include the name and contact information for the member's 210 doctor, family, or employer. Additionally, the member 210 may update previously stored emergency contact information in step 270. Electronically storing emergency contact information in step 260 and updating previously stored emergency contact information in step 270 may be accomplished by methods similar to those methods use to store and update medical directives in steps 240 and 250, respectively. The directives and contact information are stored in a memory 295, the memory 295 capable of being searched.

The system will automatically generate notifications on a predetermined basis to member 210 indicating that a medical directive corresponding to the member 210 is currently stored on the system and reminding them to submit updated personal and contact information and updated directives if appropriate. A default value, for example, one year, may be initially established as the predetermined period of time. A notification to the member 210 may be accomplished by an electronic mail sent to the member 210 or a letter sent to the member's postal address. Additionally, a member 210 may, in step 280, request that a notification be sent to the member 210 at other intervals, or may request in step 280 that no notification is sent to the member 210.

Any or all of the functions available to a member 210 of the system may be restricted by the use of a security function. The security function may be designed to verify the identity of the member 210. The security function may require a member 210 to submit a password to the system before gaining access to any or all of the system functions. The security function may require a member 210 to provide other identifying information instead of or in addition to a password, such as a personal identification number, a fingerprint, or a retinal scan.

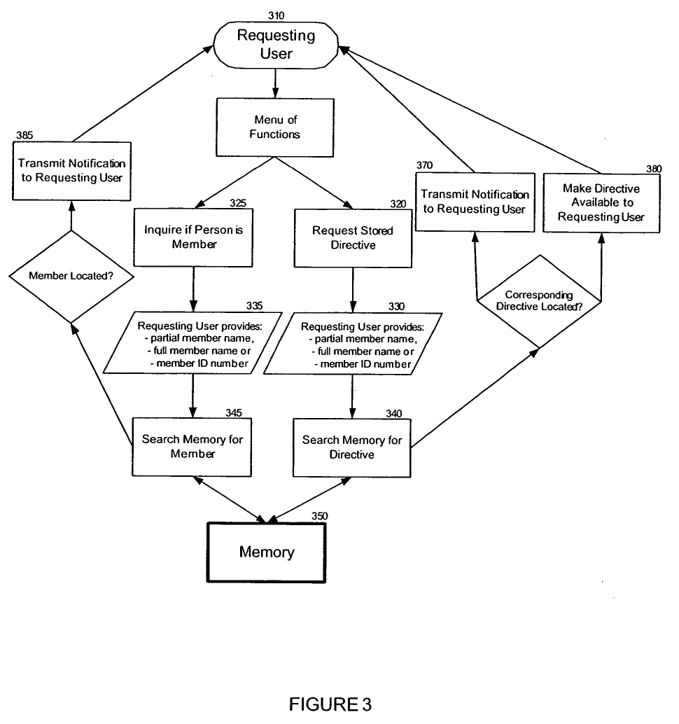

FIG. 3 further details a system and method for retrieving a medical directive. A requesting user 310 requests a medical directive from the system in step 320. In step 330, the requesting user 310 provides information to fulfill the search request. The search request information may comprise: the name of a member, an identification number of a member, a name and identification number in combination, or some other identification information. The identification number may be an identification number that was assigned to the member and then made available to the requesting user 310. Alternatively, the identification number may be the member's social security number.

The memory 350 is searched. in step 340, for a medical directive corresponding to the information provided by the requesting user 310. If a corresponding medical directive is found in the memory 350, corresponding emergency contact information and the corresponding medical directive is made available to the requesting user 310 in step 380. Providing for the availability of the corresponding medical directive in step 380 to the requesting user 310 may comprise: displaying the corresponding medical directive on a computer display, electronically mailing the corresponding medical directive to the requesting user 310, physically mailing the corresponding medical directive to the requesting user's 310 postal address, or providing the requesting user 310 with a password enabling the electronic display of the corresponding medical directive. Additionally, emergency contact information corresponding to the member, if stored on the system, may be provided to the requesting user 310.

If a medical directive corresponding to the information provided by the requesting user 310 is not found stored on the system, the requesting user 310 may receive a notification in step 370 indicating that a medical directive corresponding to the provided information is not stored on the system.

If a corresponding medical directive is found in step 350, the requesting user 310 may be provided with a notification in step 370 indicating that a corresponding medical directive has been found and may be provided with emergency contact information, or with both emergency contact information and access to a medical directive. Whether the requesting user 310 receives some or all of this notification may be conditioned upon the information provided by member at time of enrollment. For example, a member 105 may choose to display only emergency contact information to the requesting user 310, but may choose not to grant the requesting user 310 general access to the member's 105 stored medical directive. Further, a member 105 may choose to require that a specified combination of information provided by the requesting user 310 be required before the requesting user 310 is granted general access to the member's 105 medical directive.

For example, if the requesting user 310 provides only a member's last name and unique system-provided identification number, the requesting user 310 may only receive a notification in step 370 indicating that a corresponding medical directive has been stored for that member and providing selective contact information. If, however, the requesting user 310 provides a member's last name and social security number, the requesting user 310 may be provided with access to the contact information and the medical directive itself. Alternatively, at this stage the requesting user 310 may be required to provide additional information, which may then allow the requesting user 310 access to the medical directive in step 380. The type of information required to be entered by the requesting user 310 may be established by the system, or may also be established by the member 105.

FIG. 3 also details how a requester can inquire, in step 325, as to whether an individual is a member 105 of the system. In step 335, the requesting user 310 may provide identification information corresponding to an individual. The information provided by the requesting user 310 may be a full or partial last name of an individual. In step 345, the memory 350 is searched for membership profiles matching the information provided by the requesting user 310 in step 335. If a matching membership profile is found in the memory 350, the requesting user 310 may be notified of the matching profile in step 385. The notification provided to the requesting user 310 in step 385 may comprise one or more members' 105 names, city and state of the members' 105 primary residence, or other membership information. In addition, the notification may list identification corresponding to members 105 whose information closely matches the information provided by the requesting user 310.

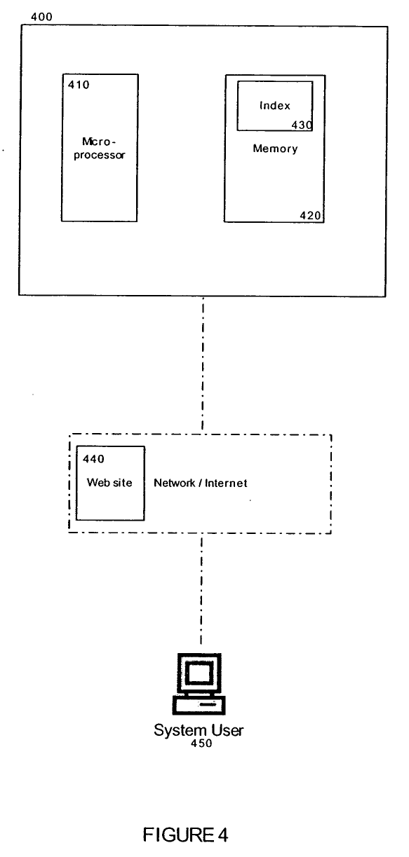

FIG. 4 illustrates the components of a system for storing and retrieving medical directives. A computer server 400 comprises a microprocessor 410 and a memory 420 in communication with the microprocessor 410. The processor 410 is a hardware device for executing software, particularly software stored in memory 420. The processor 410 can be any custom-made or commercially-available processor, a central processing unit (CPU), an auxiliary processor among several processors associated with the computer server 400, a semiconductor-based microprocessor (in the form of a microchip or chip set), or a macro-processor. Exemplary of a processor 410 practicable in accordance with the principles of the present invention are: any processing device from Hewlett-Packard Company, an 80×8 or Pentium-series microprocessor from Intel Corporation, a PowerPC microprocessor from IBM, a G-series microprocessor from IBM, a Sparc microprocessor from Sun Microsystems, Inc., or an 8-series microprocessor from Motorola Corporation.

The memory 420 can include any one or a combination of volatile memory elements (e.g., a random access memory (RAM, such as DRAM, SRAM, SDRAM, etc.) and nonvolatile memory elements (e.g., ROM, hard drive, tape, CDROM, etc.). Moreover, memory 420 may incorporate electronic, magnetic, optical, and other types of storage media. The memory 420 can have a distributed architecture where various components are situated remote from one another, but can be accessed by the processor 410.

The memory may comprise an index 430 to enable searching of the medical directives stored in the memory 420. Medical directives stored in memory 420 are accessible to a user 450 searching for a medical directive. The interface for users is a web site 440. One skilled in the art will appreciate the wide variety of computer hardware which may operate as a computer server 400 and computer user 450 in accordance with the present invention. The web site 440 is viewable by users 450 across multiple types of computer hardware and software systems equipped with browser software such as the commercially-available programs Internet Explorer, Netscape, Mozilla, Mosaic, and Opera.

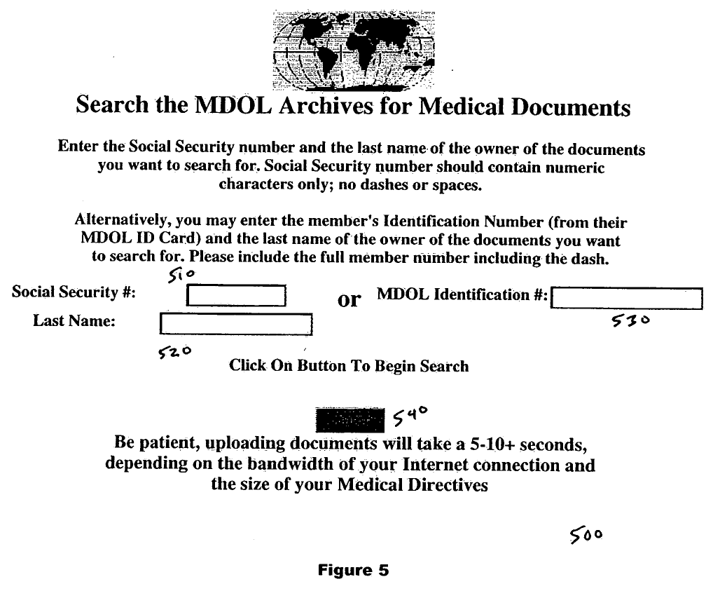

FIG. 5 is an illustration of a web page 500 designed in accordance with the principles of the present invention. The web page 500 contains a form for the entry of information corresponding to a member of the system. A requesting user may enter a member's social security number into the entry blank 510 provided, or may enter an identification number assigned to the member by the system into another entry blank 530 provided. In one embodiment of the present invention, the requesting user must additionally provide the last name of the member in the entry blank 520. After providing either a combination of last name and social security number in entry blanks 520 and 510, respectively, or providing a combination of a last name and unique identification number in entry blanks 520 and 530, the requesting user may direct the system to retrieve a medical directive corresponding to the information provided by selecting the “search” option 540.

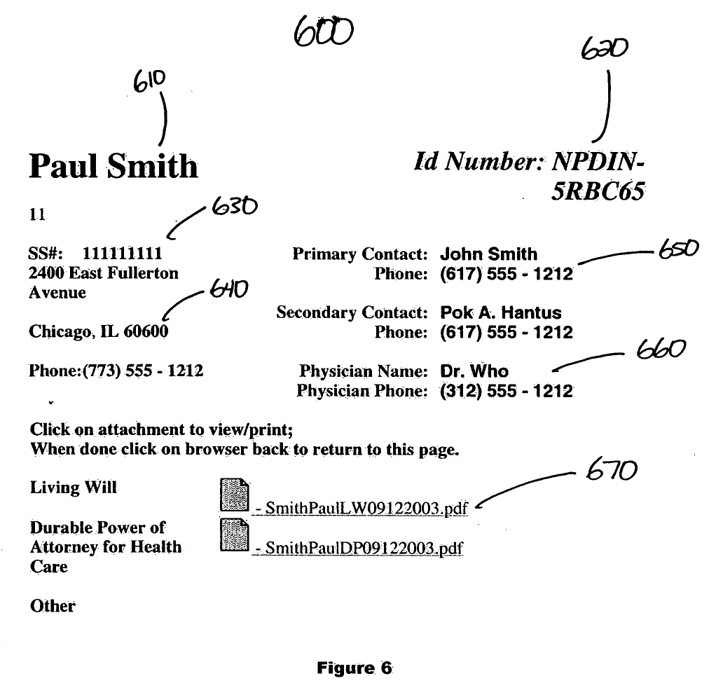

FIG. 6 is an illustration of a web page 600 designed in accordance with the principles of the present invention. The web page 600 contains information corresponding to a member of the system, such as would be displayed to a requesting user upon the requesting user's provision of identification information corresponding to the member. The web page 600 may provide the member's name 610, unique identification data 620 assigned to the member by the system, the member's address and telephone number 640, emergency contact information 650, and physician contact information 660. Additionally, the web page 600 may provide the requesting user with access to medical directives 670 corresponding to the member. The information provided on the web page 600 to the requesting user may be regulated by the member. For example, the member may choose to allow access to the medical directives 670 and emergency contact information 650, but may choose to not display the member's social security number 6xx.

It will be understood that the invention may be embodied in other specific forms without departing from the spirit or central characteristics thereof. The present embodiments, therefore, are to be considered in all respects as illustrative and not restrictive, and the invention is not to be limited to the details given herein.

1. A method of storing and retrieving a plurality of advance medical directives corresponding to a plurality of members, the method comprising the steps of:
providing for receiving a medical directive from a member;
providing for storing the medical directive in a memory, the memory capable of being searched;
providing for receiving a request for a medical directive from a user, the request comprising an identifier corresponding to one of the plurality of members;
providing for searching the memory for a medical directive corresponding to the identifier received from the user; and
providing for the availability of the corresponding medical directive to the user.

2. The method of claim 1, wherein the identifier comprises one of either a name, an identification number, or a name and identification number.

3. The method of claim 1, further comprising the step of:
providing for a database, the database capable of storing information corresponding to one of the plurality of members.

4. The method of claim 1, further comprising the step of:
providing for electronically transmitting the corresponding medical directive to the user.

5. The method of claim 1, wherein the medical directive is one of either a written document, a recorded sound, or a recorded audio-visual event.

6. The method of claim 1, further comprising the step of:
providing for transmitting a message to the user, the message comprising a notice indicating whether the member has a corresponding medical directive stored in the memory.

7. The method of claim 1, wherein the identification number received from the user is the Social Security number of the member.

8. The method of claim 1, wherein the name received from the user is the name of the member.

9. The method of claim 1, further comprising the step of:
providing for assigning a unique identification number to the member.

10. The method of claim 9, wherein the identification number received from the user is the unique identification number assigned to the member.

11. The method of claim 1, further comprising the steps of:
providing for receiving emergency contact information from the member; and
providing for storing the emergency contact information in the memory.

12. The method of claim 1, further comprising the step of:
providing for the availability to the user of emergency contact information corresponding to the member.

13. The method of claim 1, further comprising the steps of:
providing for receiving a second medical directive from a member who has a first medical directive stored in the memory; and
providing for storing the second medical directive in the memory.

14. The method of claim 1, further comprising the step of:
providing for notifying a member that a medical directive corresponding to the member has been stored in the memory for longer than a predetermined period of time.

15. The method of claim 1, further comprising the step of:
providing for allowing a member to regulate a user's access to a medical directive corresponding to the user.

16. The method of claim 1, further comprising the step of:
providing for requiring a member to transmit information identifying the member.

17. A system for storing and retrieving a plurality of advance medical directives corresponding to a plurality of members, the system comprising:
a processor for executing an application; and
a memory in communication with the processor, the memory capable of being searched;
wherein the application comprises:
a first code segment for receiving a medical directive from a member;
a second code segment for storing the medical directive in the memory;
a third code segment for receiving a request for a medical directive from a user, the request comprising an identifier corresponding to one of the plurality of members;
a fourth code segment for searching the memory for a medical directive corresponding to the search request received from the user; and
a fifth code segment for providing the corresponding medical directive to the user.

18. The system of claim 17, wherein the identifier comprises one of either a name, an identification number, or a name and identification number.

19. The system of claim 17, further comprising:
a database, the database capable of storing information corresponding to one of the plurality of members.

20. The system of claim 17, further comprising:
a sixth code segment for electronically transmitting the corresponding medical directive to the user.

21. The system of claim 17, wherein the medical directive is one of either a written document, a recorded sound, or a recorded audio-visual event.

22. The system of claim 17, further comprising:
a sixth code segment for transmitting a message to the user, the message comprising a notice indicating whether the member has a corresponding medical directive stored in the memory.

23. The system of claim 17, wherein the identification number received from the user is the Social Security number of the member.

24. The system of claim 17, wherein the name received from the user is the name of the member.

25. The system of claim 17, further comprising:
a sixth code segment for assigning a unique identification number to the member.

26. The system of claim 25, wherein the identification number received from the user is the unique identification number assigned to the member.

27. The system of claim 17, further comprising:
a sixth code segment for receiving emergency contact information from the member; and
a seventh code segment for storing the emergency contact information in the memory.

28. The system of claim 17, further comprising:
a sixth code segment for providing to the user emergency contact information corresponding to the member.

29. The system of claim 17, further comprising:
a sixth code segment for receiving a second medical directive from a member who has a first medical directive stored in the memory; and
a seventh code segment for storing the second medical directive in the memory.

30. The system of claim 17, further comprising:
a sixth code segment for notifying a member that a medical directive corresponding to the member has been stored in the memory for longer than a predetermined period of time.

31. The system of claim 17, further comprising:
a sixth code segment for allowing a member to regulate a user's access to a medical directive corresponding to the user.

32. The system of claim 17, further comprising:
a sixth code segment for requiring a member to transmit information identifying the member.

33. A method of storing and providing an advance medical directive, the method comprising the steps of:
providing a medical directive to be stored in a memory, the memory capable of being searched with a search key;
providing identification data to a user to be associated with the stored medical directive;
searching the memory for the medical directive, the search key being the identification data provided to the user;
providing the corresponding medical directive to the user.

34. The method of claim 33, wherein the identification data comprises one of either a name, an identification number, or a name and identification number.

35. The method of claim 33, further comprising the step of:
providing a database, the database capable of storing information corresponding to one of the plurality of members.

36. The method of claim 33, further comprising the step of:
electronically transmitting the corresponding medical directive to the user.

37. The method of claim 33, wherein the medical directive is one of either a written document, a recorded sound, or a recorded audio-visual event.

38. The method of claim 33, further comprising the step of:
transmitting a message to the user, the message comprising a notice indicating whether the member has a corresponding medical directive stored in the memory.

39. The method of claim 33, wherein the identification number provided to the user is the Social Security number of the member.

40. The method of claim 33, where the name provided to the user is the name of the member.

41. The method of claim 33, further comprising the step of:
providing emergency contact information to be stored in the memory.

42. The method of claim 33, further comprising the step of:
providing emergency contact information to the member.

43. The method of claim 33, further comprising the step of:
providing for receiving a notification that a medical directive has been stored in the memory for longer than a predetermined period of time.

44. The method of claim 33, further comprising the step of:
regulating a user's access to a medical directive.

45. The method of claim 33, further comprising the step of:
requiring a member to transmit information identifying the member.

46. A method of storing and retrieving a plurality of advance medical directives corresponding to a plurality of members, the method comprising the steps of:
electronically receiving a medical directive from a member;
storing the medical directive in a memory, the memory capable of being searched with a search key;
providing identification data to a user, the identification data identifying a member and comprising one of either a name, an identification number or a name and identification number;
receiving a request for a medical directive corresponding to a member, the request comprising the identification data of the corresponding member;
searching the memory for a medical directive corresponding to the search request received from the user, the search key being the identification data provided to the user;
transmitting a message to the user, the message comprising a notice indicating whether or not the member has a corresponding medical directive stored in the memory; and
transmitting the medical directive to the user if a medical directive corresponding to the member is found in the memory.

47. The method of claim 46, wherein the identification number received from the user is the Social Security number of the member.

48. The method of claim 46, wherein the name received from the user is the name of the member.

49. The method of claim 46, further comprising the step of:
providing for a database, the database capable of storing information corresponding to one of the plurality of members.

50. The method of claim 46, wherein the medical directive is one of either a written document, a recorded sound, or a recorded audio-visual event.

51. The method of claim 46, further comprising the step of:
assigning a unique identification number to the member.

52. The method of claim 51, wherein the identification number received from the user is the unique identification number assigned to the member.

53. The method of claim 46, further comprising the steps of:
receiving emergency contact information from the member; and
storing the emergency contact information in the memory.

54. The method of claim 46, further comprising the step of:
transmitting to the user emergency contact information corresponding to the member.

55. The method of claim 46, further comprising the steps of:
receiving a second medical directive from a member who has a first medical directive stored in the memory; and
storing the second medical directive in the memory.

56. The method of claim 46, further comprising the step of:
notifying a member that a medical directive corresponding to the member has been stored in the memory for longer than a predetermined period of time.

57. The method of claim 46, further comprising the step of:
allowing a member to regulate a user's access to a medical directive corresponding to the member.

58. The method of claim 46, further comprising the step of:
providing for requiring a member to transmit information identifying the member.
